(19) United States
(12) Patent Application Publication
(10) Pub. No.: US 2011/0171530 A1
(43) Pub. Date: Jul. 14, 2011

(54) CATHODE ACTIVE MATERIAL, AND NONAQUEOUS SECONDARY BATTERY HAVING CATHODE INCLUDING CATHODE ACTIVE MATERIAL

(76) Inventors: Shogo ESAKI, Osaka-shi (JP); Motoaki NISHIJIMA, Osaka-shi (JP); Takeshi YAO, Kyoto-shi (JP); Mitsuhiro HIBINO, Kyoto-shi (JP); Akira FUJITA, Kyoto-shi (JP)

(21) Appl. No.: 12/985,517

(22) Filed: Jan. 6, 2011

(30) Foreign Application Priority Data
Jan. 8, 2010 (JP) 2010-003384

(51) Int. Cl. H01M 4/50

(52) U.S. Cl. 429/224; 252/182.1

(57) ABSTRACT

A cathode active material (1) of the present invention includes: a main crystalline phase (2) including a lithium-containing transition metal oxide containing manganese and having a spinel structure, and in the cathode active material used in a nonaqueous secondary battery, the main crystalline phase (2) includes a layer-shaped sub crystalline phase (3) which is different in elementary composition from that of the lithium-containing transition metal oxide but having an oxygen arrangement identical to that of the lithium-containing transition metal oxide and which has a spinel structure.

This Nonprovisional application claims priority under 35U.S.C. §119(a) on Patent Application No. 2010-003384 filed in Japan on Jan. 8, 2010, the entire contents of which are hereby incorporated by reference.

### TECHNICAL FIELD

The present invention relates to a cathode active material for attaining a long-lived nonaqueous electrolyte secondary battery. Particularly, the present invention relates to a nonaqueous electrolyte secondary battery that has been improved in storability and in life of its operating cycle.

### BACKGROUND ART

Conventionally, nonaqueous secondary batteries have often been used as a power source for portable devices, in view of their economical efficiency and like aspects. Various types of nonaqueous secondary batteries are available: the most common type of the nonaqueous secondary batteries is a nickel-cadmium battery; and recently nickel-metal hydride batteries are also becoming more available.

From among the nonaqueous secondary batteries, a lithium secondary battery that uses lithium has been partially put to practical use due to their high output potential and their high energy density. Moreover, studies on the lithium secondary battery have been eagerly conducted in recent years, to achieve an even higher performance. Currently, LiCoO₂ is available on the market as a cathode material of the lithium secondary battery. However, due to the expensiveness of cobalt that is used as the raw material of LiCoO₂, LiMn₂O₄ using manganese, a cheaper raw material than cobalt, has been receiving attention.

However, with LiMn₂O₄, repetition of an operating cycle causes Mn contained in the cathode active material to solve out as Mn ions, and Mn thus solved out is separated on an anode as a metal Mn in the charge and discharging process. The metal Mn separated on the anode reacts with lithium ions in an electrolytic solution, and as a result, causes a remarkable decrease in capacity as a battery.

Various methods have been employed to solve this problem. For instance, Patent Literature 1 discloses a method that covers particle surfaces of manganese oxides with a polymer to prevent manganese from solving out, and Patent Literature 2 discloses a method that covers the particle surfaces of manganese oxides with boron, to prevent manganese from solving out.

Moreover, Patent Literature 3, Patent Literature 4, and Non Patent Literature 1 disclose a technique which, in order to prevent manganese from solving out, includes a substance having a different composition not including a transition element inside the LiMn₂O₄ crystal but having a similar configuration as the LiMn₂O₄ crystal in an electrode material.

### CITATION LIST

### Patent Literature 1

Japanese Patent Application Publication, Tokukai, No. 2000-231919 A (Publication Date: Aug. 22, 2000)

### Patent Literature 2

Japanese Patent Application Publication, Tokukaihei, No. 9-265984 A (Publication Date: Oct. 7, 1997)

### Patent Literature 3

Japanese Patent Application Publication, Tokukai, No. 2001-176513 A (Publication Date: Jun. 29, 2001)

### Patent Literature 4

Japanese Patent Application Publication, Tokukai, No. 2003-272631 A (Publication Date: Sep. 26, 2003)

### Non Patent Literature 1

Mitsuhiro Hibino, Masayuki Nakamura, Yuji Kamitaka, Naoshi Ozawa and Takeshi Yao, Solid State Ionics Volume 177, Issues 26-32, Oct. 31, 2006, Pages 2653-2656.

### SUMMARY OF INVENTION

### Technical Problem

Although the conventional configuration prevents the loss of Mn from the cathode active material, the conventional configuration becomes the cause of other problems.

More specifically, each of the cathode active material disclosed in Patent Literature 1 and Patent Literature 2 has the surface of LiMn₂O₄ be coated with a different insulating substance; this causes a remarkable increase in electric resistance from the LiMn₂O₄ particles. Hence, there is a drawback that output characteristics of the battery are deteriorated.

Moreover, although the cathode active material disclosed in Patent Literature 3, Patent Literature 4, and Non Patent Literature 1 have their high temperature characteristics improved by including, into the electrode material, a substance having a structure similar to the LiMn₂O₄ crystal to prevent manganese from solving out from LiMn₂O₄ upon charging or discharging the secondary battery, this does not solve the problem in cycle characteristics at room temperature.

The present invention is accomplished in view of the foregoing problem, and its object is to achieve a long-lived cathode active material in which solving out of Mn is prevented, while mixing no additives or the like into the electrolyte or any expensive elements such as Co or Ni.

### Solution to Problem

In order to attain the object, a cathode active material according to the present invention is a cathode active material used in a nonaqueous secondary battery, the cathode active material including: a main crystalline phase including a lithium-containing transition metal oxide containing manganese and having a spinel structure, the main crystalline phase including a layer-shaped sub crystalline phase, the sub crystalline phase being different in elementary composition from that of the lithium-containing transition metal oxide however including an oxygen arrangement identical to that of the lithium-containing transition metal oxide.

In a case where the cathode active material according to the present invention is used as a cathode material of a secondary battery, it is possible to physically block solving out of Mn from the cathode active material to the ion conductor in the charge and discharge process by a layer-shaped sub crystalline phase. Namely, the sub crystalline phase serves as a barrier for preventing the solving out of Mn. Hence, it is possible to provide a cathode active material capable of attaining a nonaqueous electrolyte secondary battery that can accomplish (i) reduction in solving out of Mn and (ii) large improvement in cycle characteristics.

Furthermore, in a case where the cathode active material is used as the cathode material of the nonaqueous secondary battery, the sub crystalline phase is not involved in the charge and discharge reaction. Hence, it is possible to physically prevent the expansion or shrinkage that occurs when lithium is eliminated from or inserted into the main crystalline phase, by the sub crystalline phase. Consequently, it is possible to reduce inner stress of crystal particles made of the cathode active material; as a result, cracking, breaking or the like of the crystal particles become difficult to occur. Hence, it is possible to provide a cathode active material that can attain a nonaqueous electrolyte secondary battery in which decrease in discharge capacity is difficult to occur.

Moreover, a nonaqueous secondary battery according to the present invention includes a cathode; an anode; and a nonaqueous ion conductor, the anode containing an anode active material into which a substance containing lithium or lithium is insertable or from which the substance containing lithium or lithium can be eliminated; the cathode including a cathode active material, the cathode active material being used in a nonaqueous second battery, the cathode active material including a main crystalline phase including a lithium-containing transition metal oxide containing manganese and having a spinel structure, the main crystalline phase including a layer-shaped sub crystalline phase, the sub crystalline phase being different in elementary composition from that of the lithium-containing transition metal oxide however including an oxygen arrangement identical to that of the lithium-containing transition metal oxide.

A cathode of the nonaqueous secondary battery contains the cathode active material. Hence, it is possible to accomplish reduction in solving out of Mn, thereby allowing attainment of a nonaqueous electrolyte secondary battery having largely improved cycle characteristics. Furthermore, this allows attainment of a nonaqueous electrolyte secondary battery that has a discharge capacity which is difficult to decrease.

### Advantageous Effects of Invention

With a cathode active material according to the present invention, a sub crystalline phase serves as a barrier that prevents the solving out of Mn. Hence, it is possible to provide a cathode active material that accomplishes reduction of solving out of Mn, and attains a nonaqueous electrolyte secondary battery that is largely improved in cycle characteristics. Furthermore, since inner stress of crystal particles that construct the cathode active material is reduced, thereby making it difficult to have cracking or the like occur in the crystal particles, an effect is attained that a cathode active material is obtained which is capable of producing a nonaqueous electrolyte secondary battery that has a discharge capacity difficult to be reduced in capacity.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates an embodiment of the present invention, and is a perspective view illustrating a configuration of a cathode active material.

FIG. 2 illustrates an embodiment of the present invention, and is a photographic view illustrating a HAADF-STEM image of a cathode active material obtained in Example 1.

FIG. 3 illustrates an embodiment of the present invention, and is a photographic view illustrating an EDX-element map of the cathode active material obtained in Example 1.

FIG. 4 illustrates an embodiment of the present invention, and is a photographic view illustrating a HAADF-STEM image of a cathode active material obtained in Example 2.

FIG. 5 illustrates an embodiment of the present invention, and is a photographic view of an EDX-element map of the cathode active material obtained in Example 2.

FIG. 6 is a photographic view illustrating a HAADF-STEM image of a cathode active material obtained in Comparative Example 1.

FIG. 7 is a photographic view illustrating an EDX-element map of cathode active material obtained in Comparative Example 1.

### DESCRIPTION OF EMBODIMENTS

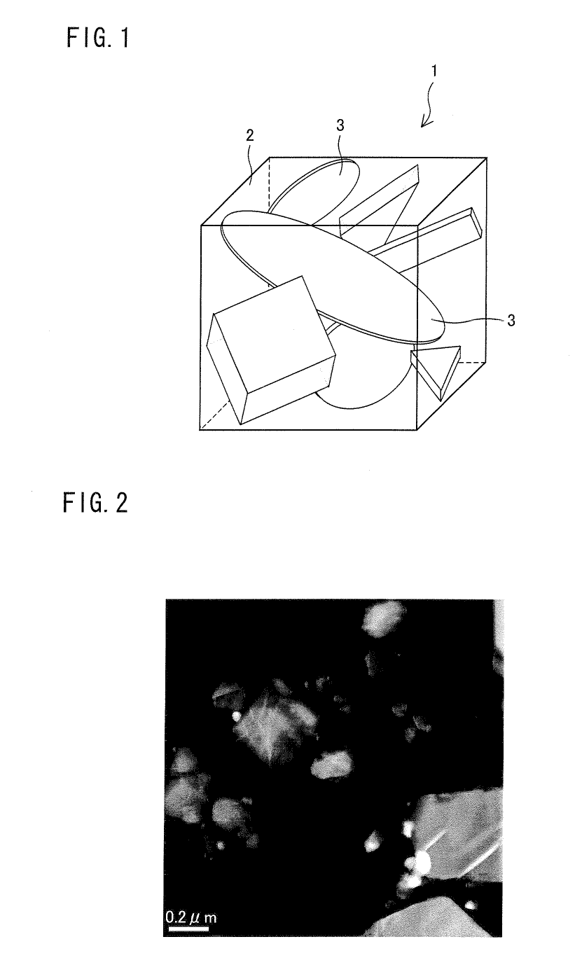

One embodiment of the present invention is described below with reference to FIG. 1. In the specification, a cathode active material refers to cathode active material for a nonaqueous electrolyte secondary battery, a cathode refers to a cathode for a nonaqueous electrolyte secondary battery, and a secondary battery refers to a nonaqueous electrolyte secondary battery.

A cathode active material according to the present invention includes a main crystalline phase including a lithium-containing transition metal oxide containing manganese and having a spinel structure, the main crystalline phase including a layer-shaped sub crystalline phase, the sub crystalline phase being different in elementary composition from that of the lithium-containing transition metal oxide however including an oxygen arrangement identical to that of the lithium-containing transition metal oxide. Note that the lithium-containing transition metal oxide is abbreviated to lithium-containing oxide, as appropriate.

<Cathode Active Material>

Main Crystalline Phase

A cathode active material according to the present invention has a main crystalline phase as its main phase. The main crystalline phase includes a lithium-containing oxide that contains manganese. In general, the lithium-containing transition metal often has a spinel structure, however even if the lithium-containing transition metal does not have the spinel structure, this still can be used as the lithium-containing oxide of the present invention.

Namely, the lithium-containing oxide has a composition including at least lithium, manganese, and oxygen. Moreover, a transition metal other than manganese may be included. The transition metal other than manganese is not particularly limited as long as the transition metal does not obstruct the function of the cathode active material. Specific examples of the transition metal encompass: Ti, V, Cr, Ni, and Cu.

However, the lithium-containing oxide preferably includes just manganese as the transition metal, in view that the lithium-containing transition metal oxide can be synthesized easily.

A composition ratio of the lithium-containing oxide, in a case of the spinel structure, can be represented as Li:M:O=1:2:4, where the transition metal that includes manganese is M. The transition metal M may include the foregoing Ti, V, Cr, Ni, Cu and/or the like.

However, in the case of the spinel structure, the composition ratio often varies from the Li:M:O=1:2:4 in practice, and the same applies with the cathode active material according to the present invention. A composition ratio of a non-stoichiometric compound having a different oxygen content from the foregoing composition ratio is, for example, Li:M:O=1:2:3.5-4.5 or 4:5:12.

In a case where the cathode active material of the present invention includes just a small mixed amount of the lithium-containing oxide, there is a possibility that a discharge capacity of the secondary battery that makes the cathode active material a cathode material be reduced in capacity. Hence, in a case where an entire composition including the main crystalline phase and sub crystalline phase is represented by the following general formula A:

Li₁₋ₓM1₂₋₂ₓM2ₓM3₂ₓO_{4-y},

where M1 is at least one type of element of manganese or of manganese and a transition metal element, each of M2 and M3 are at least one type of element of a representative metal element or of a transition metal element,
x in the general formula A is preferably 0.01≦x≦0.20, is more preferably 0.01≦x≦0.10, is further preferably 0.02≦x≦0.10, is particularly preferably 0.03≦x≦0.10, is extremely preferably 0.05≦x≦0.10, and is most preferably 0.03≦x≦0.07.

Moreover, it is preferable that 0≦y≦2.0, is further preferable that 0≦y≦1.0, and is particularly preferable that 0≦y≦0.5. Moreover, y is a value that satisfies electrical neutrality with x, and y can at times be 0. Specific examples of M2 and M3 are, for example, M2 being Sn and M3 being Zn, or M2 being Mg and M3 being Al.

Sub Crystalline Phase

A sub crystalline phase according to the present invention is a compound that has an oxygen arrangement same as that of the lithium-containing oxide, however is composed having a different elementary composition. Namely, the sub crystalline phase includes a compound different from the lithium-containing oxide however has an oxygen arrangement that is identical to that of the lithium-containing oxide. Having the same oxygen arrangement denotes that both the lithium-containing oxide and the sub crystalline phase have an oxygen arrangement of a cubic closed-packed structure. This oxygen arrangement is not necessarily a complete cubic close-packed structure; more specifically, the oxygen arrangement can be distorted in any axis direction, or can include a partial oxygen defect or an oxygen defect may be regularly arranged. The sub crystalline phase is one of a cubic crystal, tetragonal crystal, orthorhombic crystal, monoclinic crystal, trigonal crystal, hexagonal crystal, or triclinic crystal. An example of a cubic crystal compound is MgAl₂O₄, an example of a tetragonal crystal compound is ZnMn₂O₄, and an example of an orthorhombic crystal compound is CaMn₂O₄. The composition of these sub crystalline phases do not need to be stoichiometric; Mg or Zn can be partially substituted by another element such as Li or like element, or may contain a defect.

As such, in a case where the oxygen arrangement of the sub crystalline phase is identical to the oxygen arrangement of the lithium-containing oxide, the sub crystalline phase bonds to the main crystalline phase via the same oxygen arrangement, with good affinity. As a result, the sub crystalline phase can stably be present on a grain boundary and interface of the main crystalline phase.

Furthermore, in a case where the sub crystalline phase has the spinel structure, it is possible to have the sub crystalline phase be present on the grain boundary and interface of the main crystalline phase with a further high affinity.

The sub crystalline phase preferably includes, as a contained element, a representative element and manganese. The foregoing structure, by including manganese and the representative element in the composition of the sub crystalline phase, allows stabilizing the sub crystalline phase that includes the oxygen arrangement identical to that of the lithium-containing oxide. Hence, it is possible to further reduce the solving out of Mn from the sub crystalline phase.

Furthermore, the sub crystalline phase preferably includes zinc and manganese. The foregoing structure, by including zinc and manganese in the composition of the sub crystalline phase, allows particularly stabilizing the sub crystalline phase including the oxygen arrangement identical to that of the lithium-containing oxide. Hence, it is possible to particularly preferably reduce the solving out of Mn from the sub crystalline phase.

Particularly, in a case where the sub crystalline phase contains zinc and manganese, a composition ratio Mn/Zn of zinc and manganese is preferably 2<Mn/Zn<4, and is further preferably 2<Mn/Zn<3.5. It is preferable to have the composition ratio of zinc and manganese in the foregoing range since the solving out of Mn is preferably reduced. Note that the representative element, zinc, and manganese are considered as elements that transfer from the main crystalline phase during a manufacturing process of the cathode active material described later.

It is preferable that a lattice constant of the main crystalline phase in a case where the main crystalline phase is a cubic crystal or is approximately a cubic crystal is not less than 8.22 Å but not more than 8.25 Å. If the lattice constant of the main crystalline phase is within the foregoing range, the sub crystalline phase can be bonded to the main crystalline phase with good affinity, since the lattice constant matches with gaps between oxygen atoms and an arrangement of the oxygen atoms on an arbitrary side of the sub crystalline phase that has an oxygen arrangement identical to that of the main crystalline phase. Hence, it is possible to have the sub crystalline phase be stably present on the grain boundary and interface of the main crystalline phase.

With the cathode active material according to the present invention, the sub crystalline phase is provided inside the main crystalline phase so as to have a layer shape. Therefore, in a case where the cathode active material is used as a cathode material of the secondary battery, it is possible to physically block, with use of the sub crystalline phase, Mn from solving out into the ion conductor from the cathode active material during the charge and discharge process. That is to say, the sub crystalline phase serves as a barrier that prevents Mn from solving out; as a result, it is possible to reduce the solving out of Mn. This makes it possible to provide a cathode active material that can achieve a nonaqueous electrolyte secondary battery having remarkably improved cycle characteristics.

FIG. 1 is a perspective view illustrating a cathode active material 1 according to the present embodiment. As illustrated in FIG. 1, the cathode active material 1 includes a main crystalline phase 2 and a sub crystalline phase 3, and the sub crystalline phase 3 is formed as having a layer-shape inside the main crystalline phase 2. Hence, when Mn solves out from the main crystalline phase 1, the sub crystalline phase 3 serves as a barrier, by which the solving out of Mn is prevented. Since the sub crystalline phase 3 is of a layer shape, the lithium-containing oxide can be covered even if the sub crystalline phase 3 is mixed by a small amount in the cathode active material 1. Hence, it is possible to prevent Mn from solving out.

The sub crystalline phase 3 of the layer shape is recognizable by observing the cathode active material 1 with a known electron microscope. The electron microscope used may be, for example, a HAADF-STEM or like microscope.

The sub crystalline phase 3 preferably has a layer thickness of not less than 1 nm but not more than 100 nm. If the thickness of the sub crystalline phase 3 is within the foregoing range, it is possible to attain a thickness of the sub crystalline phase 3 that can preferably reduce the solving out of Mn, while not obstructing transfer of Li ions from the cathode active material, which obstruction is caused by the sub crystalline phase 3 being too thick.

If the amount of the sub crystalline phase mixed in the cathode active material of the present invention is great, a relative amount of the lithium-containing oxide decreases when the cathode active material is used as a cathode material of a secondary battery. This may cause the discharge capacity of the cathode active material to decrease. On the other hand, if the amount of the sub crystalline phase mixed in the cathode active material is small, the effect of preventing Mn from solving out from the main crystalline phase decreases, thereby reducing the effect of improving the cycle characteristics of the secondary battery. Hence, this is not preferable.

In consideration of these matters and in consideration of a balance between the decrease in discharge capacity and attainment of the effect of improving cycle characteristics, a preferable mixed amount of the sub crystalline phase with respect to the cathode active material is an amount in which, in the general formula A, x is in the range of 0.01≦x≦0.10, further preferably in the range of 0.03≦x≦0.07.

Moreover, the inventors found as a result of diligent study that the sub crystalline phase of the main crystalline phase preferably has a crystallinity that is detectable by diffractometry (crystal diffractometry). Such a sub crystalline phase has high crystallinity, and in a case where the cathode active material is used as the active material of the secondary battery, it is possible to physically hold down expansion or shrinking that occurs upon insertion of lithium into or elimination of lithium from the main crystalline phase. Hence, it is possible to reduce inner stress of crystal particles that are included in the cathode active material, and as a result, makes it difficult to cause the crystal particles to crack or the like. Consequently, it is possible to provide a cathode active material capable of attaining a secondary battery that makes it difficult to have the discharge capacity decrease.

<Production Method of Secondary Battery>

The following description deals with how to produce the secondary battery. First described is how a raw compound of a sub crystalline phase is produced, which raw compound of the sub crystalline phase serves as raw material of the cathode active material.

Producing Raw Compound of Sub Crystalline Phase

How to produce a spinel-type compound that is a raw material compound of the sub crystalline phase is not particularly limited; a known method of producing a solid solution, a hydrothermal method, or the like can be used. Moreover, a sol-gel process or spray pyrolysis may also be used.

In producing the spinel-type compound by the method of producing a solid solution, raw material including an element to be included in the sub crystalline phase is used as the raw material of the spinel-type compound. Oxides and chlorides such as carbonates, nitrates, sulfates, and hydrochlorides, each of which include the element, can be used as the raw material.

More specifically, examples of the raw material encompass: manganese dioxide, manganese carbonate, manganese nitrate, lithium oxide, lithium carbonate, lithium nitrate, magnesium oxide, magnesium carbonate, magnesium nitrate, calcium oxide, calcium carbonate, calcium nitrate, aluminium oxide, aluminum nitrate, zinc oxide, zinc carbonate, zinc nitrate, iron oxide, iron carbonate, iron nitrate, tin oxide, tin carbonate, tin nitrate, titanium oxide, titanium carbonate, titanium nitrate, vanadium pentoxide, vanadium carbonate, vanadium nitrate, cobalt oxide, cobalt carbonate, and cobalt nitrate.

Moreover, the following may be used as the raw material: a hydrolysate Meₓ(OH)ₓ of a metal alkoxide including an element Me contained in the sub crystalline phase, where Me is, for example, manganese, lithium, magnesium, aluminium, zinc, iron, tin, titanium, vanadium or the like, and X is a valence of the element Me; or a solution of a metal ion including the element Me. The solution of the metal ion is used as the raw material in a state in which the solution is mixed with a thickening agent or a chelating agent.

The thickening agent and chelating agent are not particularly limited, and a known thickening agent can be used. For example, thickening agents such as ethylene glycol and carboxymethyl cellulose and chelating agents such as ethylenediaminetetraacetic acid and ethylene diamine can be used.

The spinel-type compound is obtained by mixing and baking the raw material so that an element content in the raw material is of a composition ratio of a target sub crystalline phase. A baking temperature is adjusted in accordance with a temperature of the raw material used, so it is difficult to set the temperature so as to have no alternative. However, the baking is typically carried out at a temperature of not less than 400° C. but not more than 1500° C. An atmosphere to carry out the baking may be inactive, or may include oxygen.

Moreover, synthesis of the spinel-type compound is also possible by a hydrothermal method, in which an acetate, chloride or the like is dissolved in an alkaline aqueous solution in a well-closed container, which acetate, chloride or the like are raw material including the element included in the spinel-type compound, and this mixture is heated. In a case where the spinel-type compound is synthesized by the hydrothermal method, an obtained spinel-type compound can be used in a subsequent process of producing the cathode active material, or can be used in the process of producing the cathode active material after the obtained spinel-type compound is treated by heat.

If the spinel-type compound obtained by the foregoing method has an average particle size larger than 100 μm, it is preferable that the average particle size is made smaller. The average particle size of the spinel-type compound may be made smaller by, for example, crushing the spinel-type compound with a mortar, a planetary ball mill or the like to reduce the particle size, or by classifying the particle size of the spinel-type compound with a mesh or the like and using the spinel-type compound having a small average particle size in the subsequent processes.

Production of Cathode Active Material

Subsequently, the cathode active material is produced by carrying out, to the obtained spinel-type compound: (1) synthesis of the spinel-type compound at a single phase state, mixing to the synthesized spinel-type compound a lithium source material and manganese source material which are raw material of the lithium-containing oxide, and thereafter baking this mixture; or (2) synthesis of the spinel-type compound at a single phase state, further mixing to the synthesized spinel-type compound a lithium-containing oxide that is synthesized separately to the spinel-type compound, and thereafter baking this mixture. As described above, the cathode active material according to the present embodiment is produced by use of a spinel-type compound obtained in advance.

In a case where the method (1) is used, first, the spinel-type compound is mixed with the lithium source material and manganese source material in accordance with a desired lithium-containing oxide.

Examples of the lithium source material encompass lithium carbonate, lithium hydroxide, lithium nitrate and the like. Moreover, examples of the manganese source material encompass manganese dioxide, manganese nitrate, manganese acetate and the like. It is preferable to use electrolytic manganese dioxide as the manganese source material.

Moreover, transition metal raw material that includes a transition metal other than manganese can be used together with the manganese source material. Examples of the transition metal encompass Ti, V, Cr, Ni, Cu and like transition metals, and oxides and chlorides (e.g., carbonates, hydrochlorides and the like) of these transition metals can be used as the transition metal raw material.

After the lithium source material and manganese source material (including transition metal raw material) to be mixed are selected, the lithium source material and the manganese source material (including the transition metal raw material) are mixed into the spinel-type compound so that a ratio of Li in the lithium source material and a ratio of the manganese source material (including the transition metal raw material) in the lithium source material become ratios of a preferred lithium-containing oxide. For example, in a case where the preferred lithium-containing oxide is LiM₂O₄ (M is manganese and a transition metal), content of the lithium source material and manganese source material (including transition metal raw material) is set so that the ratio of Li to M is 1:2.

After the spinel-type compound, lithium source material, and manganese source material are mixed so as to have the set content, these materials are evenly mixed together (mixing process). A known mixing equipment such as a mortar or a planetary ball mill is usable in the mixing process.

Entire amounts of the spinel-type compound, the lithium source material, and the manganese source material may be mixed at once, or small amounts of the lithium source material and manganese source material can be gradually added to the entire amount of the spinel-type compound. The latter case causes a gradual decrease in concentration of the spinel-type compound, which allows mixing the mixture to be more evenly mixed. For this reason, the latter case is more preferable.

The mixed raw material is further baked, to produce the cathode active material (baking process). In order to easily bake the mixed raw material, the mixed raw material is preferably shaped into a pellet shape by applying pressure, and thereafter is baked in the pellet shape. The baking temperature is set depending on the types of mixed raw material, however is typically baked in a temperature range of not less than 400° C. but not more than 1000° C. Moreover, a typical baking time is preferably not more than 12 hours.

Baking within this baking time range allows an intermediate phase including a part of elements of the main crystalline phase and a part of elements of the sub crystalline phase to be present on an interface of the main crystalline phase with the sub crystalline phase, in the obtained cathode active material. With such an interface formed, the main crystalline phase can be strongly bonded with the sub crystalline phase. Hence, it is possible to obtain a cathode active material in which breakage and the like is further difficult to occur.

The interface is a borderline on which the main crystalline phase and the sub crystalline phase are in contact with each other. Furthermore, the intermediate phase is a region that is present on the interface of the main crystalline phase with the sub crystalline phase, in which the elements of the main crystalline phase and those of the sub crystalline phase are mixed together. The intermediate phase includes the elements that are included in the main crystalline phase and those included in the sub crystalline phase in a mixed manner, in different proportions per type of element. The intermediate phase is a phase different from the main crystalline phase or the sub crystalline phase, and is constituted of one or more types of compound that includes all or part of the elements included in the main crystalline phase and the sub crystalline phase. This compound(s) includes a solid solution. Moreover, the proportion of the elements that are included in the intermediate phase may vary depending on position. For instance, the proportion of the mixed elements may differ in the intermediate phase between a position close to the main crystalline phase and a position close to the sub crystalline phase.

Moreover, whether or not the main crystalline phase and the sub crystalline phase are formed as a solid solution can be confirmed by X-ray diffractometry. More specifically, if both a peak of the main crystalline phase and a peak of the sub crystalline phase are detected, then the main crystalline phase and the sub crystalline phase are not formed as a solid solution. In comparison, if the sub crystalline phase is mixed into the main crystalline phase as a solid solution, the peak of the sub crystalline phase cannot be detected, and further the peak of the main crystalline phase in the X-ray diffractometry profile largely shifts as compared to the peak in the case where the sub crystalline phase is not mixed into the main crystalline phase as a solid solution.

It is not preferable to carry out baking for a long period of time, since such baking causes an entire amount of the spinel-type compound to disperse into the main crystalline phase, thereby possibly forming a complete solid solution. In a case where a complete solid solution is formed, the spinel-type compound cannot be formed to have a layer-shape.

The baking may be carried out under air atmosphere, or may be carried out under an atmosphere having increased oxygen content. Moreover, the baking process may be repeated several times. In this case, the baking for a first time (pre-baking) and the baking for second and subsequent times may be carried out at a same temperature or at different temperatures. Furthermore, in the case where the baking is repeated a plurality of times, a sample may be crushed and again be shaped into a pellet shape by applying pressure, while the plurality of baking processes are carried out.

An extremely preferable method for producing the cathode active material is to (i) synthesize Zn₂SnO₄ at a single phase state, which Zn₂SnO₄ is a spinel compound including a part of raw material of the sub crystalline phase, (ii) mix the raw material with lithium source material and Mn and thereafter (iii) bake this mixture. This is because the cathode active material obtained as a result achieves largely improved cycle characteristics of the secondary battery.

Production of Cathode

The cathode active material obtained as described above is processed into a cathode by the following known procedure. The cathode is formed by use of a mixture in which the cathode active material, a conductive additive material, and a binding agent are mixed together.

The conductive additive material is not particularly limited, and a known conductive additive material can be used. Examples thereof include: carbons such as carbon black, acetylene black, and KETJENBLACK; graphite (natural graphite, synthetic graphite) powder; metal powder; metal fiber; and the like.

The binding agent is not particularly limited, and a known binding agent can be used. Examples thereof encompass: fluorinated polymers such as polytetrafluoroethylene and polyvinylidene fluoride; polyolefin polymers such as polyethylene, polypropylene, and ethylene-propylene-diene terpolymer; and styrene-butadiene rubber.

An appropriate mixing ratio of the conductive additive material and the binding agent differs depending on the type of the mixed conductive additive material and binding agent, and is difficult to set so as to have no alternative. However, typically, the mixing ratio of the conductive additive material is not less than 1 part by weight to not more than 50 parts by weight and the mixing ratio of the binding agent is not less than 1 part by weight to not more than 30 parts by weight, each with respect to 100 parts by weight of the cathode active material.

If the mixing ratio of the conductive additive material is less than 1 part by weight, resistance, polarization or the like of the cathode increases and the discharge capacity decreases. Hence, a practical secondary battery may not be produced with the obtained cathode. On the other hand, if the mixing ratio of the conductive additive material exceeds 50 parts by weight, the mixed ratio of the cathode active material included in the cathode decreases. This causes the discharge capacity as the cathode to decrease.

Moreover, if the mixing ratio of the binding agent is less than 1 part by weight, a binding effect may not be expressed. On the other hand, if the mixing ratio of the binding agent exceeds 30 parts by weight, the amount of active material included in an electrode decreases as with the case of the conductive additive material, and furthermore, as described above, the resistance, polarization or the like of the cathode increases and the discharge capacity decreases. Hence, this is not practical.

Other than the conductive additive material and the binding agent, the mixture may also use a filler, a dispersing agent, an ion conductor, a pressure enhancing agent, and other various additives. The filler can be used without any particular limitations as long as the filler is fiber material that does not chemically change in properties in the obtained secondary battery. Usually, olefin polymers such as polypropylene and polyethylene, and fibers such as glass are used as the filler. The filler is not particularly limited in its added amount, however is preferably not less than 0 parts by weight to not more than 30 parts by weight with respect to the mixture.

The method of forming the mixture in which the cathode active material, the conductive additive material, the binding agent, various additives and the like are mixed together, is not particularly limited. Examples of such a method include: a method of forming a pellet-shaped cathode by compressing the mixture; and a method of forming a sheet-shaped cathode by preparing a paste by (i) adding an appropriate solvent to the mixture, (ii) applying this paste on a collector, and thereafter (iii) drying and further compressing this collector on which the paste is applied.

The collector carries out transfer of electrons from or to the cathode active material in the cathode. Accordingly, the collector is provided to the cathode active material. Sole metal, an alloy, a carbon or the like is used as the collector. For instance, a sole metal such as titanium or aluminium, an alloy such as stainless steel, or carbon is used. Moreover, a collector having a surface made of copper, aluminium, or stainless steel on which a carbon, titanium, or silver layer is formed, or, a collector whose surface made of copper, aluminium, or stainless steel is oxidized, may also be used.

Examples of a shape of the collector, other than a foil-shape, encompass a film, a sheet, a net, and a punched-out shape. The collector may be configured as a lath structure, porous structure, foam, formed fibers, or like structure. The collector used in the embodiment has a thickness of not less than 1 μm but not more than 1 mm; however, the thickness thereof is not particularly limited.

Production of Anode

An anode of the secondary battery of the present invention includes an anode active material, which can have (a) a substance including lithium or (b) lithium be inserted into or eliminated from the anode active material. In other words, the anode includes an anode active material in which (a) the substance including lithium or (b) lithium can be occluded or discharged.

A known anode active material is used as the anode active material. Examples of the anode active material encompass: lithium alloys such as metal lithium, lithium/aluminum alloy, lithium/tin alloy, lithium/lead alloy, and wood's alloy; a substance that can electrochemically dope and dedope lithium ion such as conductive polymers (polyacetylene, polythiophene, and polyparaphenylene), pyrolytic carbon, pyrolytic carbon which has been subjected to gas-phase pyrolysis in the presence of a catalyst, carbon baked from pitch, coke, tar or the like, and carbon baked from a polymer such as cellulose, phenolic resin or the like; graphite with which intercalation/deintercalation of lithium ions is possible, such as natural graphite, synthetic graphite, and expanded graphite; and inorganic compounds that can dope/dedope lithium ions, such as WO₂, and MoO₂. These substances may be used solely, or a complex made of a plurality types thereof may be used.

Among these anode active material, use of pyrolytic carbon, pyrolytic carbon which has been subjected to gas-phase pyrolysis in the presence of a catalyst, carbon baked from pitch, coke, tar or the like, carbon baked from a polymer, or graphite (e.g., natural graphite, synthetic graphite, and expanded graphite) allows producing a secondary battery that has preferable battery characteristics, particularly in terms of safety. Particularly, it is preferable that graphite is used for producing a high voltage secondary battery.

In a case where a conductive polymer, carbon, graphite, inorganic compound or the like is used in the anode active material to serve as the anode, a conductive additive material and binding agent may be added to the anode active material.

As the conductive additive material, carbons such as carbon black, acetylene black, and KETJENBLACK, graphite (natural graphite, synthetic graphite) powder, metal powder, metal fiber, and the like can be used. However, the conductive additive material is not limited to these examples.

Moreover, fluorinated polymers such as polytetrafluoroethylene and polyvinylidene fluoride, polyolefin polymers such as polyethylene, polypropylene, and ethylene-propylene-diene terpolymer, and styrene-butadiene rubber may be used as the binding agent. However the binding agent is not limited to these examples.

Ion Conductor and Method of Forming Secondary Battery

As an ion conductor that is included in the secondary battery according to the present invention, a known ion conductor can be used. For instance, an organic electrolytic solution, solid electrolyte (inorganic solid electrolyte, organic solid electrolyte), fused salt or the like can be used; from among these ion conductors, the organic electrolytic solution is suitably used.

The organic electrolytic solution is made of an organic solvent and an electrolyte. Examples of the organic solvent encompass general organic solvents which are aprotic organic solvents: esters such as propylene carbonate, ethylene carbonate, butylene carbonate, diethyl carbonate, dimethyl carbonate, methyl ethyl carbonate, and γ-butyrolactone; tetrahydrofuran; substituted tetrahydrofuran such as 2-methyltetrahydrofuran; ethers such as dioxolane, diethyl ether, dimethoxyethane, diethoxyethane, and methoxyethoxyethane; dimethylsulfoxide; sulfolane; methylsulfolane; acetonitrile; methyl formate; and methyl acetate. These organic solvents may be used solely, or a mixed solvent of two or more organic solvents may be used.

Moreover, examples of the electrolyte encompass lithium salts such as lithium perchlorate, lithium borofluoride, lithium phosphofluoride, lithium arsenate hexafluoride, lithium trifluoromethanesulfonate, lithium halide, and lithium aluminate chloride. One type of the lithium salts may be used or two or more types of the lithium salts may be used in combination. An electrolyte appropriate for the aforementioned solvent is selected, and the two are dissolved together to prepare an organic electrolytic solution. The solvents and electrolytes used to prepare the organic electrolytic solution are not limited to the foregoing examples.

Nitrides, halides, and oxysalts of Li are examples of the inorganic solid electrolyte which is a solid electrolyte. Specific examples encompass: Li₃N, LiI, Li₃N—LiI—LiOH, LiSiO₄, LiSiO₄—LiI—LiOH, Li₃PO₄—Li₄SiO₄, phosphorous sulfide compounds, and Li₂SiS₃.

Examples of the organic solid electrolyte which is a solid electrolyte encompass: a substance including the electrolyte included in the organic electrolyte and a polymer that carries out dissociation of electrolytes; and a substance in which its polymer has an ionizable group.

Examples of the polymer that carries out electrolyte dissociation encompass: a polyethylene oxide derivative or a polymer including this derivative; a polypropylene oxide derivative or a polymer including this derivative; and a phosphoester polymer. Moreover, other methods which add, to the electrolyte: (i) a polymer matrix material containing the aprotic polar solvent, (ii) a mixture of a polymer including an ionizable group and the aprotic electrolyte, or (iii) polyacrylonitrile, are also available. Further, a method that uses both an inorganic solid electrolyte and an organic solid electrolyte is also well known.

In the secondary battery, nonwoven or woven fabric made of material such as electric insulating synthetic resin fiber, glass fiber, or natural fiber; micropore structural material; a molded object of powder such as aluminum, or the like may be used as a separator for retaining the electrolyte fabric. Among these separators, the nonwoven fabric made of synthetic resin such as polyethylene and polypropylene, and the micropore-structured body are preferable in view of attaining a stable quality. Some separators made of the nonwoven fabric of synthetic resin and the micropore-structured body have a function that when the battery abnormally generates heat, the separator melts due to the heat to block electrical connection between the cathode and the anode. In view of safety, such a separator is also suitably used. A thickness of the separator is not particularly limited, and as long as a required amount of electrolyte is retainable and short-circuiting of the cathode and anode can be prevented, the thickness can be any thickness. Generally, a separator having a thickness of not less than 0.01 mm but not more than 1 mm is used, and preferably the thickness is not less than 0.02 mm and not more than 0.05 mm.

The secondary battery can be of any shape: coin-shaped, button-shaped, sheet-shaped, cylinder-shaped, angular-shaped, or the like. In the case of the coin-shaped and button-shaped secondary battery, a general method is to (i) form the cathode and anode in the pellet-shape, (ii) place the cathode and anode in a battery can that has a can structure including a lid, and (iii) caulk (fix) the lid in a state in which an insulating packing is sandwiched between the can and the lid.

On the other hand, in the case of the cylinder-shaped and angular-shaped secondary battery, (i) a sheet-shaped cathode and an anode are inserted in a battery can, (ii) the sheet-shaped cathode and the anode are electrically connected to the secondary battery, (iii) the electrolyte is injected, and (iv) a sealing plate is sealed via an insulating packing, or the sealing plate is insulated from the battery can by hermetic sealing, to prepare the secondary battery. At this time, a safety valve having a safety component may be used as the sealing plate. The safety component may be, for example, a fuse, bimetal, PTC (positive temperature coefficient) component or the like, so as to serve as an overcurrent preventing component. Moreover, other than the safety valve, methods such as opening a crack in a gasket, opening a crack in the sealing plate, opening a cut in the battery can and like methods may be used to prevent inner pressure of the battery can from rising. Moreover, an external circuit that incorporates overcharging and overdischarging measures can be used.

The pellet-shaped or sheet-shaped cathode and anode are preferably dried or dehydrated in advance. The cathode and anode can be dried or dehydrated by a general method. For instance, the cathode and anode can be dried by use of, solely or in combination, hot air, vacuum, infrared rays, electron beam, and/or low-moisture air. It is preferable that the temperature is not less than 50° C. but not more than 380° C.

Examples of a method for injecting the electrolyte into the battery can include a method in which injection pressure is applied to the electrolyte and a method in which difference in pressure between negative pressure and atmospheric pressure is utilized. However, how the electrolyte is injected is not limited to these methods. An injected amount of the electrolyte is also not particularly limited, however it is preferable that the amount allows immersing the cathode, the anode, and the separator completely in the electrolyte.

Methods of how to charge and discharge the produced secondary battery include a constant current charge and discharge method, a constant voltage charge and discharge method, and a constant power charge and discharge method; it is preferable to use different methods in accordance with an evaluation purpose of the battery. The foregoing methods can be used solely or in combination to carry out the charging and discharging.

The cathode of the secondary battery according to the present invention includes the cathode active material. Hence, with the secondary battery of the present invention, it is possible to obtain a nonaqueous electrolyte secondary battery that can attain a low solving out of Mn and which is greatly improved in cycle characteristics. Furthermore, it is possible to achieve a nonaqueous electrolyte secondary battery having a low possibility that the discharge capacity decreases.

Moreover, the present invention includes the following mode. Namely, in the cathode active material according to the present invention, the sub crystalline phase is preferably a tetragonal crystal or an orthorhombic crystal, and preferably has a spinel structure.

With the foregoing crystal structures, the main crystalline phase and the sub crystalline phase can have identical oxygen arrangements.

Moreover, with the cathode active material according to the present invention, the sub crystalline phase preferably has a crystallinity that is detectable by diffractometry. Examples of the diffractometry include X-ray diffractometry, neutron diffractometry, and electron diffractometry.

The sub crystalline phase has high crystallinity; in a case where the cathode active material is used as a cathode material of the nonaqueous secondary battery, it is possible to physically prevent the expansion or shrinkage that occurs when lithium is eliminated from or inserted into the main crystalline phase. This allows reducing inner stress in crystal particles that are included in the cathode active material; as a result making it further difficult for the crystal particles to crack or the like. Hence, it is possible to provide a cathode active material that can attain a nonaqueous electrolyte secondary battery having a low possibility that the discharge capacity is reduced.

Moreover, with the cathode active material according to the present invention, it is preferable that the main crystalline phase and the sub crystalline phase have an intermediate phase sandwiched therebetween at their interface, the intermediate phase being constituted of a part of elements of the main crystalline phase and a part of elements of the sub crystalline phase.

By forming an interface as the aforementioned in the cathode active material, the main crystalline phase and the sub crystalline phase are strongly bonded together. Hence, it is possible to obtain a cathode active material having a less possibility of the generation of a crack or the like.

Moreover, with the cathode active material according to the present invention, it is preferable that 0.01≦x≦0.10, where a whole composition including the main crystalline phase and the sub crystalline phase is represented by the following general formula: Li₁₋ₓM1₂₋₂ₓM2ₓM3₂ₓO_{4-y}, where M1 is at least one element of manganese or manganese and a transition metal element, M2 and M3 are each at least one element of a representative metal element or a transition metal element; and, y is a value satisfying electrical neutrality with x. Moreover, it is preferable that y satisfies an inequation of 0≦y≦2.0, further preferably satisfies an inequation of 0≦y≦1.0, and particularly preferably satisfies an inequation of 0≦y≦0.5. The y is a value that satisfies electrical neutrality with x, and y can be the value of 0.

If the proportion of the sub crystalline phase, i.e., x is in the foregoing range, use of the cathode active material as a cathode material of the nonaqueous secondary battery allows attaining a suitable balance between the reduction in discharge capacity of the nonaqueous secondary battery and improvement of the cycle characteristics.

Moreover, with the cathode active material according to the present invention, it is preferable that the lithium-containing transition metal oxide contains just manganese as a transition metal.

In such a case, the lithium-containing transition oxides can be easily synthesized, thereby simplifying a manufacturing process of the cathode active material.

Moreover, with the cathode active material according to the present invention, the sub crystalline phase preferably includes manganese and a representative element. In the present invention, a transition metal is an element that has a d orbital incompletely filled with electrons or an element that causes generation of such a positive ion; a representative element denotes any other element. For example, an electron configuration of a zinc atom Zn is 1s²2s²2p⁶3s²3p⁶4s²3d¹⁰, and a positive ion of zinc is Zn²⁺, which is 1s²2s²2p⁶3s²3p⁶3d¹⁰. The atom and the positive ion are both 3d¹⁰, and do not have “an incompletely filled d orbital”; hence, Zn is a representative element.

By having the composition of the sub crystalline phase include manganese and a representative element as in the configuration, it is possible to stabilize the sub crystalline phase that includes an oxygen arrangement identical to that of the lithium-containing oxide. Hence, this allows further holding down the solving out of Mn from the sub crystalline phase.

Moreover, with the cathode active material according to the present invention, the sub crystalline phase preferably includes zinc and manganese.

By having the composition of the sub crystalline phase contain zinc and manganese as in the configuration, it is possible to particularly stabilize the sub crystalline phase that includes an oxygen arrangement identical to that of the lithium-containing oxide. Hence, this particularly preferably allows further holding down the solving out of Mn from the sub crystalline phase.

Moreover, in the cathode active material according to the present invention, it is preferable that the sub crystalline phase includes zinc and manganese so as to have a composition ratio Mn/Zn that satisfies an inequation of: 2<Mn/Zn<4.

It is preferable that the composition ratio of zinc and manganese is in the foregoing range, since the solving out of Mn is preferably reduced.

Moreover, in the cathode active material according to the present invention, it is preferable that the sub crystalline phase has a thickness of not less than 1 nm but not more than 100 nm.

The sub crystalline phase having a thickness in the foregoing range makes it possible to secure a thickness of the sub crystalline phase that allows reducing the solving out of Mn, while avoiding the thickness of the sub crystalline phase from becoming too thick, which thickness may obstruct transferring of Li ions from the cathode active material.

Moreover, with the cathode active material according to the present invention, the lithium-containing transition metal oxide preferably has a lattice constant of not less than 8.22 Å but not more than 8.25 Å.

By having a lattice constant of the lithium-containing transition metal oxide be in the foregoing range, it is easy to cause the sub crystalline phase have an oxygen arrangement identical to that of the lithium-containing transition metal oxide. Hence, such a configuration is extremely preferable.

### EXAMPLES

The following description further specifically explains the present invention by use of Examples. However, the present invention is not limited to these Examples. Bipolar cells (secondary battery) and cathode active materials obtained in Examples and Comparative Examples were measured to find out the following measurements.

<Operating Cycle Test>

Operating cycle tests were carried out to the obtained bipolar cells under conditions of: a current density of 0.5 mA/cm², a voltage in a range from 4.3 V to 3.2 V, and at temperatures of 25° C. and 60° C. An average value of discharge capacities calculated based on those taken from after the cycle was repeated five times until after the cycle was repeated ten times, served as an (initial discharge capacity), and a discharge capacity maintenance rate obtained by the operating cycle test was evaluated by use of an average value of discharge capacities (discharge capacity after 100 cycles) calculated based on those taken from after 98 cycles were carried out to after 102 cycles were carried out or an average value of discharge capacities (discharge capacity after 200 cycles) calculated based on those taken after 198 cycles were carried out to after 202 cycles were carried out. The discharge capacity maintenance rate was calculated by calculating: {(discharge capacity after 100 cycles)/(initial discharge capacity)}×100, or {(discharge capacity after 200 cycles)/(initial discharge capacity)}×100.

<Photographing HAADF-STEM Image>

The obtained cathode active material powder was set up on resin whose main component is silicon, and the cathode active material was processed, by use of Ga ions, to be cubes of 10 μm. Furthermore, the cathode active material was irradiated with Ga ion beam from one direction, to obtain a thin film sample for STEM-EDX analysis, which sample had a thickness of not less than 100 nm but not more than 150 nm.

With respect to the thin film sample for STEM-EDX analysis, a field-emission electron microscope (HRTEM; manufactured by HITACHI Co. Ltd., Serial Number: HF-2210) was set to have an acceleration voltage of 200 kV, a sample absorption current of 10⁻⁹ A, and a beam diameter of 0.7 nmφ, to obtain a HAADF-STEM image.

<Photographing EDX-Element Map>

With respect to the thin film sample for STEM-EDX analysis obtained in the photographing of the STEM image, the field-emission electron microscope (HRTEM; manufactured by HITACHI Co. Ltd., Serial Number HF-2210) was set to have the acceleration voltage of 200 kV, the sample absorption current of 10⁻⁹ A, and a beam diameter of 1 nmφ. The thin film sample was irradiated with the beam for 40 minutes, to obtain an EDX-element map.

### Example 1

Zinc oxide was used as zinc source material, and tin (IV) oxide was used as tin source material; these materials were weighed so that a molar ratio of zinc to tin was 2:1. Thereafter, these material were mixed for 5 hours with an automated mortar. Further, the mixed material was baked under air atmosphere for 12 hours at 1000° C., thereby obtaining a baked product. After the baking, the obtained baked product was crushed and thereafter mixed for 5 hours with the automated mortar. This produced a spinel-type compound.

As lithium source material and manganese source material included in the lithium-containing oxide, lithium carbonate and electrolytic manganese dioxide were used, respectively; these materials were weighed so that a molar ratio of lithium to manganese was 1:2. Furthermore, the spinel-type compound was weighed so that the spinel-type compound and the main crystalline phase satisfies x=0.05 in the general formula A. The lithium carbonate, electrolytic manganese dioxide and spinel-type compound were mixed for 5 hours with the automated mortar, and this mixture was prebaked under the air atmosphere condition for 12 hours at 550° C. An obtained baked product was crushed and thereafter mixed for 5 hours with the automated mortar, thereby obtaining a powder.

The powder was molded to a pellet-shape, and this molded object was baked under air atmosphere condition for 12 hours at 800° C. An obtained baked product was crushed and thereafter mixed for 5 hours with the automated mortar, to obtain the cathode active material.

Moreover, the cathode active material, acetylene black as a conductive additive material, and polyvinylidene fluoride as a binding agent were mixed in a ratio of 80 parts by weight, 15 parts by weight, and 5 parts by weight, respectively, and further this mixture was mixed with N-methyl pyrrolidone so that the mixture was prepared as a paste. This paste was applied on an aluminium foil having a thickness of 20 μm, so that a thickness of the paste thus applied became not less than 50 μm but not more than 100 μm. After this paste-applied object was dried, the paste-applied object was punched to be of a disk-shape having a diameter of 15.958 mm, and was vacuum dried. This produced a cathode.

On the other hand, an anode was produced by punching out from a metal lithium foil of a predetermined thickness a disk-shape having a diameter of 16.156 mm. Moreover, a nonaqueous electrolytic solution as the nonaqueous electrolyte was prepared by dissolving LiPF₆, a solute, into a solvent by a proportion of 1.0 mol/l, in which solvent ethylene carbonate and dimethyl carbonate were mixed in a volume ratio of 2:1. As the separator, a porous membrane made of polyethylene having a thickness of 25 μm and a porosity of 40% was used.

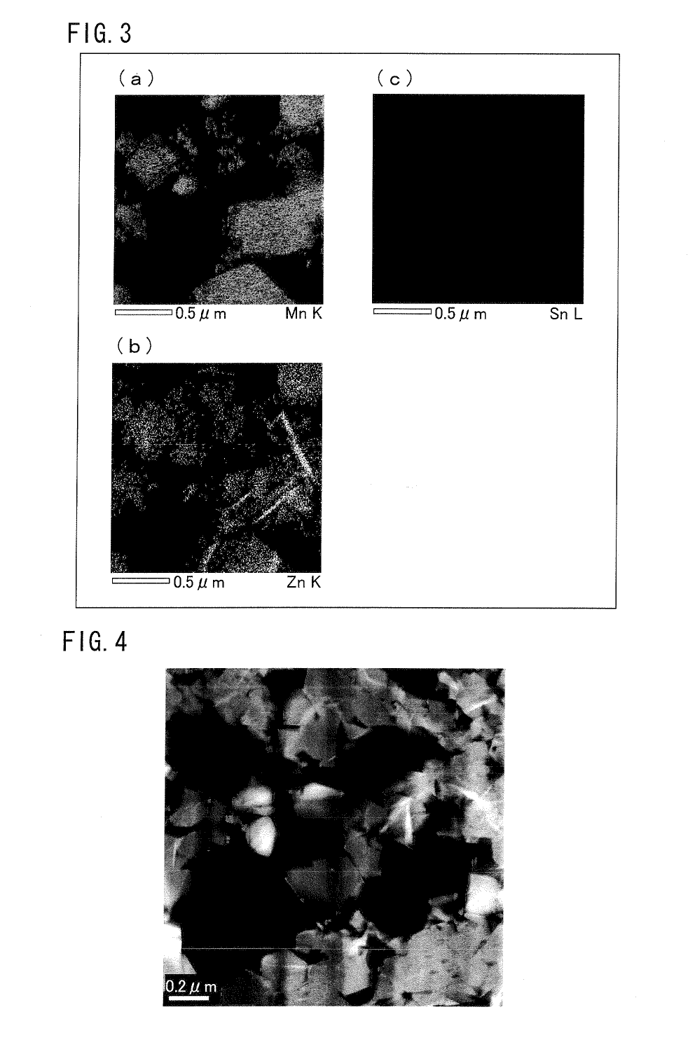

The bipolar cell was produced using the foregoing cathode, anode, nonaqueous electrolyte, and separator. Thereafter, the operating cycle test was carried out to the obtained bipolar cell. A result measured, at 25° C., of the initial discharge capacity and the content maintenance rate attained after the cycle test was carried out is shown in Table 1, and the measured result at 60° C. thereof is shown in Table 2. Moreover, the HAADF-STEM image and the EDX-element map of the obtained cathode active material were photographed. FIG. 2 is a photographic view of the HAADF-STEM image of the cathode active material obtained in Example 1, and FIG. 3 is a photographic view of the EDX-element map of the cathode active material obtained in Example 1.

The HAADF-STEM image analyzes, in a thickness direction, an entire part of a part in which the cathode active material was irradiated with the beam. It is therefore observable from FIGS. 2 and 3 that zinc and tin included in the spinel-type compound is formed as layers, with respect to manganese included in the main crystalline phase. Consequently, it is clearly understood that the spinel-type compound is formed as a layer shape in the cathode active material.

### Example 2

A synthesis similar to Example 1 was carried out, except that the starting material was changed in mixing ratio so that the spinel-type compound and the main crystalline phase satisfied x=0.10 in the general formula A. A bipolar cell was produced in the same method as Example 1. Results of the operating cycle test are shown in Tables 1 and 2.

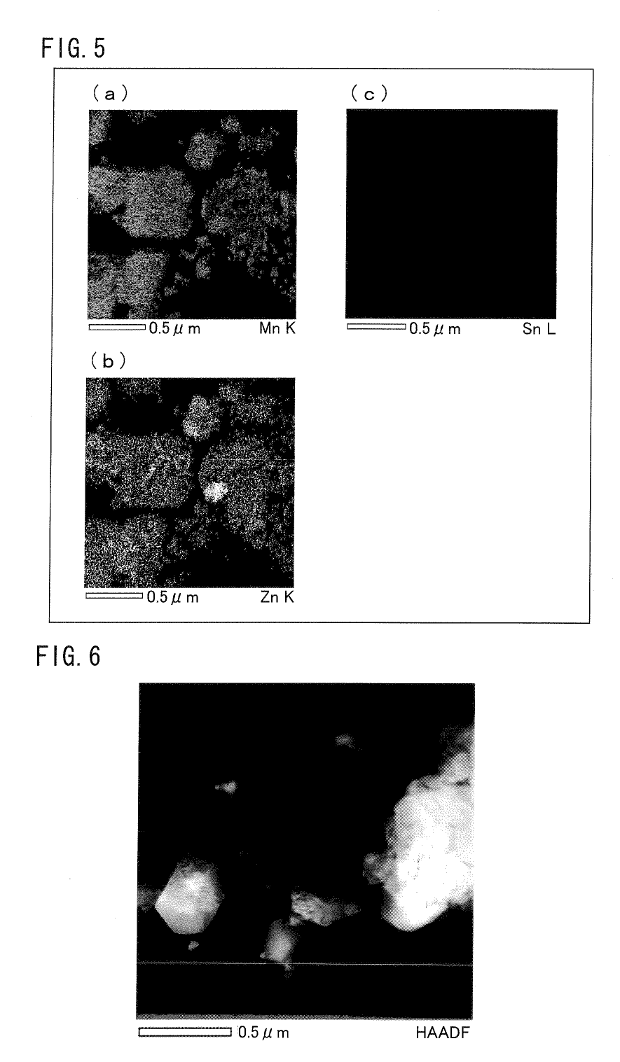

Moreover, a sample for STEM-EDX analysis was obtained by the same method as Example 1. Thereafter, a HAADF-STEM image was photographed in the same method as Example 1. This image is shown in FIG. 4. Furthermore, an EDX-element map obtained by the same method as Example 1 is shown in FIG. 5. Similarly with Example 1, it was observed from FIGS. 4 and 5 that the spinel-type compound is formed as having a layer shape in the main crystalline phase of the cathode active material obtained in Example 2.

### Example 3

A synthesis similar to Example 1 was carried out, except that the starting material was changed in mixing ratio so that the spinel-type compound and the main crystalline phase satisfied an equation of x=0.02. A bipolar cell was produced as in the same method as Example 1. Results of the operating cycle are shown in Tables 1 and 2.

### Comparative Example 1

A synthesis similar to Example 1 was carried out, except that no spinel-type compound was mixed, and just lithium carbonate as the lithium source material and eletrolytic manganese dioxide as the manganese source material were used; further, the mixing ratio of the starting substances were changed so that these materials had the molar ratio of lithium to manganese as 1:2. A bipolar cell was produced in the same method as Example 1. Results of the operating cycle test are shown in Tables 1 and 2.

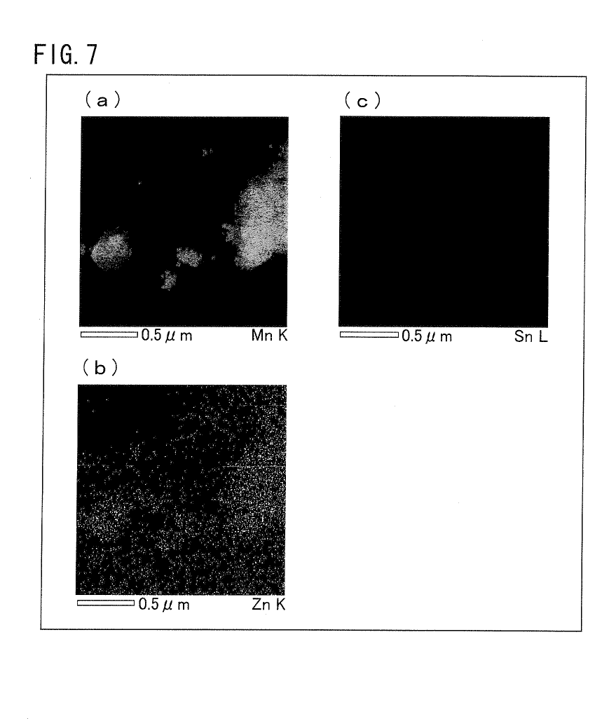

Moreover, a sample for STEM-EDX analysis was obtained by the same method as Example 1. Thereafter, a HAADF-STEM image was photographed in the same method as Example 1. This image is shown in FIG. 6. Furthermore, an EDX-element map obtained by the same method as Example 1 is shown in FIG. 7. Different from Example 1, no layered compound could be observed. Furthermore, a specific element was detected in the EDX analysis at a position in which no element should be present. Hence, the element map of Zn and Sn obtained by the EDX analysis was observed as being one caused by a noise.

TABLE 1
Operating cycle test result at 25° C.

| | Discharge capacity maintenance rate |
|---|---|
| | (%) |
| Example 1 | 90 |
| Example 2 | 91 |
| Example 3 | 87 |
| Comparative | 80 |
| Example 1 | |

TABLE 2
Operating cycle test result at 60° C.

| | Initial discharge | Discharge capacity |
|---|---|---|
| | capacity (mAh/g) | maintenance rate (%) |
| Example 1 | 91 | 73 |
| Example 2 | 76 | 84 |
| Example 3 | 90 | 65 |
| Comparative | 120 | 43 |
| Example 1 | | |

With the bipolar cells of Examples 1 to 3, particularly as clear in the result of the operating cycle test in Table 2 carried out at 60° C., the initial discharge capacity and the discharge capacity maintenance rate both showed a high value.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A cathode active material of the present invention is applicable to a nonaqueous electrolyte secondary battery that is used in portable information terminals, portable electronic apparatuses, small-size power storage apparatuses for home use, electric bicycles using a motor as its power source, electric automobiles, hybrid electric automobiles, and the like.

### REFERENCE SIGNS LIST

1 cathode active material
2 main crystalline phase
3 sub crystalline phase

What is claimed is:

1. A cathode active material used in a nonaqueous secondary battery, the cathode active material comprising:
a main crystalline phase including a lithium-containing transition metal oxide containing manganese and having a spinel structure,
the main crystalline phase including a layer-shaped sub crystalline phase, the sub crystalline phase being different in elementary composition from that of the lithium-containing transition metal oxide however including an oxygen arrangement identical to that of the lithium-containing transition metal oxide.

2. The cathode active material according to claim 1, wherein:
the sub crystalline phase is a tetragonal crystal or an orthorhombic crystal.

3. The cathode active material according to claim 1, wherein:
the sub crystalline phase has a spinel structure.

4. The cathode active material according to claim 1, wherein:
the sub crystalline phase has a crystallinity that is detectable by diffractometry.

5. The cathode active material according to claim 1, wherein:
the main crystalline phase and the sub crystalline phase have an intermediate phase sandwiched therebetween at their interface, the intermediate phase being constituted of a part of elements of the main crystalline phase and a part of elements of the sub crystalline phase.

6. The cathode active material according to claim 1, wherein:
0.01≦x≦0.10,
where a whole composition including the main crystalline phase and the sub crystalline phase is represented by the following general formula:
Li₁₋ₓM1₂₋₂ₓM2ₓM3₂ₓO_{4-y},
where M1 is at least one element of manganese or manganese and a transition metal element, M2 and M3 are each at least one element of a representative metal element or a transition metal element; and, y is a value satisfying electrical neutrality with x.

7. The cathode active material according to claim 1, wherein:
the lithium-containing transition metal oxide contains just manganese as a transition metal.

8. The cathode active material according to claim 1, wherein:
the sub crystalline phase includes a representative element and manganese.

9. The cathode active material according to claim 8, wherein:
the sub crystalline phase includes zinc and manganese.

10. The cathode active material according to claim 9, wherein:
the sub crystalline phase includes zinc and manganese so as to have a composition ratio Mn/Zn that satisfies an inequation of:
2<Mn/Zn<4.

11. The cathode active material according to claim 1, wherein:
the sub crystalline phase has a thickness of not less than 1 nm but not more than 100 nm.

12. The cathode active material according to claim 1, wherein:
the lithium-containing transition metal oxide has a lattice constant of not less than 8.22 Å but not more than 8.25 Å.

13. A nonaqueous secondary battery comprising:
a cathode;
an anode; and
a nonaqueous ion conductor,
the anode containing an anode active material into which a substance containing lithium or lithium is insertable or from which the substance containing lithium or lithium can be eliminated;
the cathode including a cathode active material,
the cathode active material being used in a nonaqueous second battery, the cathode active material including a main crystalline phase including a lithium-containing transition metal oxide containing manganese and having a spinel structure, the main crystalline phase including a layer-shaped sub crystalline phase, the sub crystalline phase being different in elementary composition from that of the lithium-containing transition metal oxide however including an oxygen arrangement identical to that of the lithium-containing transition metal oxide.
